(19) United States
(12) Patent Application Publication
(10) Pub. No.: US 2016/0292786 A1
(43) Pub. Date: Oct. 6, 2016

(54) Online Broker Evaluation Strategy

(71) Applicant: Pavel Khizhnyak, Staten Island, NY (US)

(72) Inventors: Pavel Khizhnyak, Staten Island, NY (US); Konstantin Pelykh, Santa Clara, CA (US)

(21) Appl. No.: 14/678,383

(22) Filed: Apr. 3, 2015

(51) Int. Cl. G06Q 40/04

(52) U.S. Cl. CPC G06Q 40/04

(57) ABSTRACT

The invention discloses a scheme for the effective evaluation of online brokers of Over-The-Counter (OTC) traded financial assets. The techniques disclosed evaluate online brokers on the basis of a broker-score that is derived from a pricing-score and an execution-score correspondent to each online broker. Pricing-score and execution-score are further derived from pricing data and execution data collected from trading stations/platforms supported by the online brokers. Such data collection is performed with the aid of custom Expert Advisor (EA) modules developed and installed specifically for a given trading platform, e.g. MetaTrader4 (MT4). Evaluation results are generalized across all traders as well as customized according to the trading patterns of an individual trader. The results are presented to the traders as a ranked list of brokers recommended by the evaluation scheme.

### FIELD OF THE INVENTION

This invention relates generally to the fields of online trading platforms of financial assets, and in particular to the evaluation of online, Over-The-Counter (OTC) brokers of Foreign Exchange (Forex) market.

### BACKGROUND ART

In today's world of internet connectivity, financial markets are available to people and entities who can trade financial assets/securities, commodities, and other fungible items of value at low transaction costs and at prices that reflect supply and demand, through online trading platforms, and oftentimes from the comfort of their homes. Financial securities include stocks and bonds, and commodities include precious metals or agricultural goods. It is no surprise that there are many types of financial markets, including stock markets, bond markets, commodity markets, money markets, derivatives markets, futures/forward markets, insurance markets and foreign exchange or currency market. In particular, the foreign exchange market (Forex, FX, or currency market) is a global, decentralized market for the trading of currencies. In terms of volume of trading, it is by far the largest market in the world. The online traders typically participate in the trades through online, retail brokers or banks.

In as far as evaluating such brokers of online trading markets, there are many schemes taught in the prior art. “Local Trade Copier speed of execution demonstration on MT4” by Rimantas Petrauskas on Youtube (https://www.youtube.com/watch?v=9Nfxoy2R1YM, 2013) shows the measurements of execution speed and slippage of trades for various online brokers as observed on MetaTrader4 (MT4) trading platform. In “FX Transaction Cost Analysis: Reality or Pipedream?, Larry Tabb on e-forex (http://www.e-forex.net/articles/Features/857/FX+Transaction+Cost+Analysis3A+Reality+or+Pipedream3F, 2006) analyzes the execution cost of brokers as a combination of implicit and explicit costs.

U.S. Pat. No. 7,739,182, filed Jul. 3, 2003 to David Myr teaches a multi-channel machine learning system, method and computer program for automated simultaneous transmission of a number of Buy/Sell orders generated according to self-optimized trading parameters for each independent trading strategy. Optimization could be performed according to every optimization method used. Perpetual real-time optimization (or self-optimization) of trading parameters adds machine learning feature to the invention and it is done independently for each trading strategy. A centralized trading system is provided for the individual user or organization that wants to perform his trading automatically and completely without human intervention from receiving the data from the Central Server provider to real-time Order execution in computerized financial markets. The disclosed system is working based on an API/DSK programming tools and is integrated into a network of brokers, banks and other institutions trading on computerized markets, through a number of parallel working connection channels.

In U.S. Pat. No. 8,401,955, filed Aug. 18, 2010 to Bauerschmidt et al. systems and methods are disclosed that allow trading of over the counter (“OTC”) foreign exchange (“FX”) contracts on a centralized matching and clearing mechanism, such as that of the Chicago Mercantile Exchange's (“CME”'s) futures exchange system (the “Exchange”). The disclosed systems and methods allow for anonymous transactions, centralized clearing, efficient settlement and the provision of risk management/credit screening mechanisms to lower risk, reduce transaction costs and improve the liquidity in the FX market place. In particular, the disclosed embodiments increase speed of execution facilitating growing demand for algorithmic trading, increased price transparency, lower cost of trading, customer to customer trading, and automated asset allocations, recurring trades as well as clearing and settlement efficiencies.

U.S. Patent Publication NO. 2004/0128225 A1, filed Oct. 22, 2003 to Thompson et al. teaches an apparatus and method of determining and displaying trading trends for one or more currency pairs Wherein an opening value and a closing value for the one or more currency pairs for two or more time intervals is obtained. An opening value trend using a market trend indicator and the opening values for the investment is calculated, and a closing value trend using the market trend indicator and the closing values for the one or more currency pairs is calculated. A visual indicator comparing the opening value trend to the closing value trend for the one or more currency pairs is then displayed. This method may be incorporated into a computer program embodied in a computer readable medium using code segments to accomplish the method described above.

A shortcoming of prior art teachings is that they do not provide a comprehensive framework for evaluating online brokers based on true trading costs experienced by the online traders. They also do not provide a mechanism for ranking the online brokers in a consistent fashion, based on not just pricing data but also execution data, and particularly in way that tailors the ranking to the trading profiles of individual traders.

### OBJECTS OF THE INVENTION

In view of the shortcomings of the prior art, it is an object of the present invention to teach a more effective evaluation scheme for online brokers than is available through the teachings of the prior art.

It is further an object of the invention to teach the evaluation of online brokers based on both the pricing and execution scores of individual brokers, and consequently on the true trading costs faced by the traders.

It is further an object of the invention to provide a ranking of the online brokers to the online traders and in a manner that such ranking is tailored to the individual online traders.

It is further an object of the invention to provide the basis for an independent, 3rd party tool/service that would guide traders on choosing an online broker that best fits their needs.

### SUMMARY OF THE INVENTION

The objects and advantages of the invention are given by a system and methods for evaluating one or more online brokers of Over-The-Counter (OTC) traded financial assets. The OTC financial assets preferably include, but are not limited to, stocks, bonds, commodities, futures, forwards, swaps, options, debentures and foreign exchange (Forex or FX) or currency trading. The online brokers are evaluated based on a broker-score of each online broker, and the broker-score is derived from a pricing-score and an execution-score computed for each online broker. Broker-score is representative of the true trading costs encountered by the traders. Preferably, the pricing-score of a broker is based on pricing data, and the execution-score is based on execution data of that broker.

In an advantageous embodiment, pricing data is comprised of a spread between the Bid and the Ask price of a financial asset offered by the online broker. Pricing data further comprises a commission charged by the broker on the trade of the financial asset and a swap charged/paid by the broker for carrying over a trade to the next trading day. In a related embodiment, execution data comprises an average volatility of the financial asset involved in the trade. Average volatility is computed by dividing the difference between the highest and the lowest Bid price during the time between the placement of a trade and its execution at the broker, and then dividing this difference by the number of seconds elapsed during trade placement and execution. Execution data further comprises a slippage observed by the trader in the trade, as the difference between the price of the financial asset at which the trade was submitted, and the price that the order was filled.

In another embodiment, execution data further comprises an execution speed as measured by the elapsed time between order placement by the trader and order confirmation by the broker on a trading platform, a re-quote ratio as measured by the percentage of trades that were re-quoted by the broker, a reject ratio as measured by the percentage of trades that were rejected by the broker, and an execution rate as measured by the percentage of all submitted trades that were successfully executed by the broker without a re-quote or a reject. In a highly preferred embodiment, the broker-score of each broker is calculated by summing the pricing-score and the execution-score of the broker. Preferably, the pricing-score is dependent on the local delay (network or processing delay) associated with the user of the system and its methods.

The system and methods of the invention further perform the evaluation of online brokers by producing a ranking of the brokers for a given financial asset and for a given platform. The ranking is produced based on the broker-score computed above. Such a ranking is generalized first across all traders, and then later customized to the trading patterns/profile of each individual trader. Preferably, the historical trading profile of a trader includes, but is not limited to, instruments historically traded by the trader, number of trades done historically per unit of time, position size per instrument for the historical trades, past spreads paid by the trader for the historical trades, past swaps paid and past swaps received by the trader for the historical trades.

In a highly advantageous embodiment, the OTC traded financial asset is Forex. In a related embodiment, pricing and execution data are collected using one or more trading platforms. A trading platform is preferably chosen from MetaTrader 4 (MT4), MetaTrader 5 (MT5), CTrader, ActTrader, Trader Workstation (TWS) and any other Application Programming Interface (API) enabled trading platform. TWS is provided and supported by the popular brokerage company Interactive Brokers. In a variation of this embodiment, pricing and execution data are collected with the aid of a custom Expert Advisor (EA) software module developed specifically for the trading platform. In a highly preferred related embodiment, the trading platform is MT4. Further, the pricing and execution data above are collected from either live accounts with real currency and/or demo accounts with paper or virtual currency. In another embodiment, the system and methods of the invention perform back-testing of an individual broker or a ranked list of brokers, against the historical trading data of a trader and the associated historical pricing and execution data of the broker(s), to determine a historical suitability of the broker(s) for that trader based on past trades.

The methods also delineate the steps required to carry out the teachings of the invention. Specifically, the methods provide the steps for evaluating one or more online brokers of financial assets by determining a broker-score of each online broker. The broker-score of each broker is determined based on a pricing-score and an execution-score of the broker. The pricing-score is based on pricing data and execution score is based on execution data of each broker. Broker evaluation is performed by producing a ranked list of brokers based on above broker-score, and then further customizing this list for an individual trader. The ranked list is presented to the trader using a variety of filters that the trader can use as pivots to view broker rankings.

Preferably, pricing-score is computed by multiplying an effective quantity of the financial asset involved in the trade by the spread charged by the broker (as the difference between the Bid and the Ask price), and then adding the commission charged by the broker on the trade and any swap charged by the broker for carrying the trade over to the next trading day. Preferably still, execution-score is computing by multiplying an effective quantity of the financial asset involved in the trade by the average volatility of the financial asset observed during the trade. Broker-score, pricing-score and execution-score thus computed are then aggregated across all applicable transactions to determine the overall pricing-score, execution-score and broker-score of each broker. Advantageously, there is a ‘what-if’ analysis capability for the user provided by the system and its methods.

Clearly, the system and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 is a block diagram of an online broker evaluation system according to the present invention.

FIG. 2 is a detailed diagram of the various embodiments of the online broker evaluation system of the present invention.

FIG. 3 is a variation of broker assessment module of the embodiments depicted in FIG. 2.

FIG. 4 is an exploded view of a trading station of the embodiments depicted in FIG. 2-3.

FIG. 5 depicts the steps carried out at a trading station in a flowchart form, according to the teachings of the present invention.

FIG. 6 is an exploded view of an automated demo station group of the embodiments depicted in FIG. 2-3.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

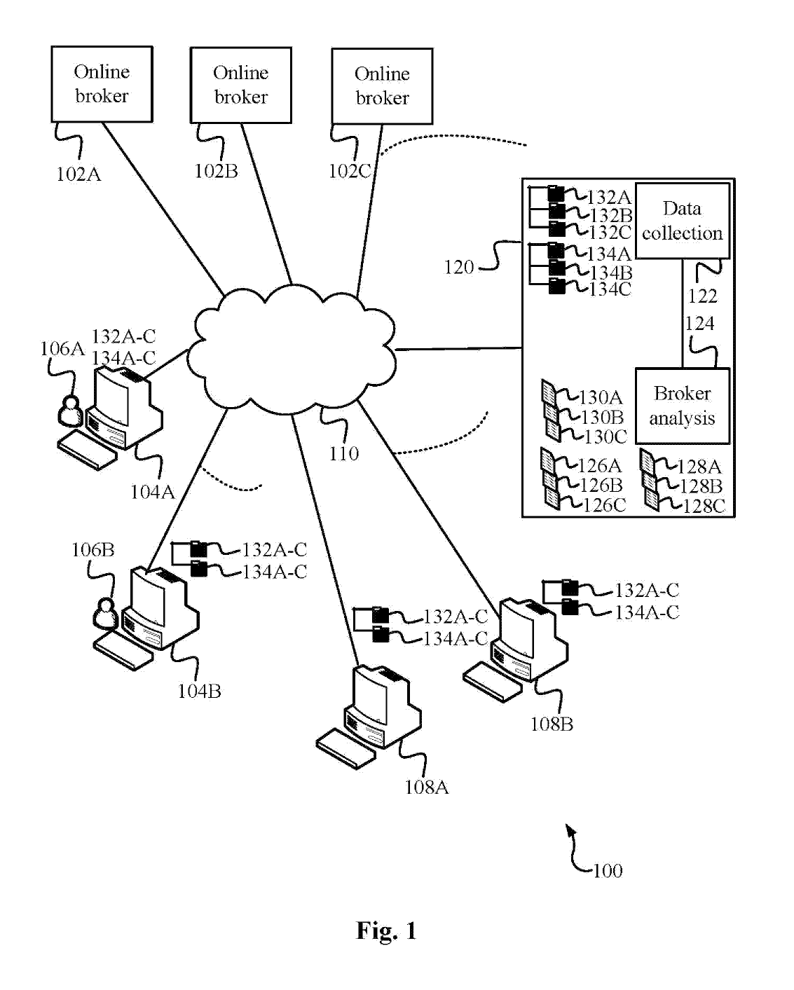

The system and methods of present invention will be best understood by first reviewing the computer system 100 for evaluating online brokers as illustrated in FIG. 1. The online broker evaluation system of FIG. 100 shows three online brokers 102A, 102B and 102C with the dotted line extending to the right of online broker 102C representing that the present invention admits any number of such online brokers that may be evaluated. System 100 further comprises users, or online traders 106A and 106B with their respective computer trading platforms 104A and 104B, as well as computer trading platforms 108A and 108B that are unmanned or automated, or in other words do not require a user to perform online trades. We are using the term users to mean human personnel using broker evaluation system 100. Users may be traders as in the case of user 106A and 106B. In the ensuing description, we may refer to a user, a trader and a client interchangeably and only draw a distinction as and when necessary. Sometimes a client may also refer to a software or an automated trading client (i.e. a robot), that is not necessarily being operated by a human being. Such use of these terms will be familiar to skilled artisans.

Once again, the invention admits of having any number of such user based online trading platforms 104A, 104B and any number of such automated online trading platforms 108A, 108B, as represented by the respective dotted lines extending to the right of platforms 104B and 108B respectively. Furthermore, it is also entirely possible to just have manned trading platforms 104A, 104B and others, without any automated or unmanned platforms 108A, 108B. Similarly, the invention allows for just having unmanned or automated trading platforms 108A, 108B and others, without any user based or manned platforms 104A, 104B.

Online trading platforms 104A, 104B and 108A, 108B have connectivity to online brokers 102 via communication network 110. Preferably online trading platforms 104A, 104B and 108A, 108B include any combination of MetaTrader 4 (MT4), MetaTrader (MT5), CTrader, ActTrader, Trader Workstation (TWS) and any other trading platforms with appropriate connectivity and extension capabilities. MetaTrader 4, also known as MT4, is a widely used electronic trading platform and is popular among online retail foreign exchange speculative traders. Communication network 110 can be the internet, or any other suitable local or wide area network as may be required to connect brokers 102A-C with traders 104A, 104B and 108A, 108B. People skilled in the art will recognize the many networking options available to provide connectivity between online communities, and these will not be delved into detail in this specification. Online broker evaluation system 100 further comprises a broker assessment module 120 that is responsible for collecting data from online brokers 102A-C via a data collection module 122, and performing broker analysis and evaluation via broker analysis module 124. Like online brokers 102A, 102B, 102C and online traders 104A, 104B and 108A, 108B, broker assessment module 120 is also connected to network 110.

In the preferred embodiment, broker evaluation system 100 has live accounts running on trading platforms 104A, 104B and 108A, 108B. As skilled artisans will recognize, live accounts at trading platforms 104A, 104B of traders 106A, 106B respectively, will generally require management by users 106A, 106B. However, it is entirely conceivable to have automated trading strategies being executed by platforms 104A, 104B on live accounts without human intervention. Of course, it is also entirely conceivable to have such automated strategies being executed at unmanned trading platforms 108A, 108B. In an alternative embodiment of the present invention, broker evaluation system 100 has demo accounts running on trading platforms 104A, 104B of traders 106A, 106B and/or in addition to trading platforms 108A, 108B. Skilled traders and online trading professionals will be familiar with such demo or paper accounts that are usually provided by online brokers for ‘practice’ trading by their novice as well as experienced customers. Unlike live trading accounts, these practice or demo accounts do not incur real costs normally associated with live transactions.

Online broker evaluation system 100 evaluates online brokers 102A-C based on a broker-score computed for each online broker 102A, 102B, 102C. A broker-score is indicative of the ‘true trading cost’ of the broker as observed by traders/users 106A-B. Furthermore, and as will be taught below, once broker-scores and the associated broker ranking has been customized for a given user/trader, e.g. 106A, a broker-score then is indicative of the true trading cost of that broker personalized for the individual trader 106A, and is a highly useful measure of the actual costs that user/trader 106A can expect to incur from that broker.

The broker-scores correspondent to each online broker 102A, 102B, 102C are shown by reference numerals 130A, 130B, 130C respectively in FIG. 1. Each such broker-score 130A, 130B, 130C for online brokers 102A, 102B, 102C is further comprised of a pricing-score 126A, 126B, 126C and an execution-score 128A, 128B, 128C respectively. Pricing-scores 126A-C and execution-scores 128A-C are further derived from pricing data and execution data of corresponding online brokers 102A-C. Pricing data and execution data correspondent to each online broker 102A, 102B, 102C is indicated by pricing data files 132A, 132B, 132C and execution data files 134A, 134B, 134C respectively in FIG. 1.

Now let us look at the working of broker evaluation system 100 in further detail. According to the apparatuses and methods of the present invention, online brokers 102A-C of system 100 in FIG. 1 can be brokering any Over-The-Counter (OTC) financial asset or security within the scope of the present invention.

Such financial assets preferably include, but are not limited to, stocks, bonds, commodities, futures, forwards, swaps, options, debentures and foreign exchange (Forex or FX) or currency trading. As will be known to skilled investors, Over-the-counter (OTC) or off-exchange trading, in contrast to an exchange based trading such as the one commonly done with financial securities offered on New York Stock Exchange (NYSE) or National Association of Securities Dealers Automated Quotations (NASDAQ), is done directly between two parties without any supervision of the exchange.

As system 100 operates over time, data collection module 122 collects pricing data and execution data corresponding to individual brokers 102A, 102B, 102C, from the live and demo accounts operating on trading platforms 104A, 104B and 108A, 108B. In other words, as traders 106A, 106B execute their manual and/or automated strategies on live and/or demo accounts on platforms 104A, 104B and as automated strategies on live and/or demo accounts are executed on platforms 108A, 108B, this results in the generation of pricing data represented by files 132A-C, and execution data represented by files 134A-C, for brokers 102A-C being used at platforms 104A, 104B and 108A, 108B as illustrated in FIG. 1. Data collection module 122 collects this data via network 110 and then provides or pushes this data to broker analysis module 124. Pricing data 132A-C and execution data 134A-C can be captured on a real-time or a near real-time basis or on a batch basis, as will be recognized by skilled artisans. Further, pricing data 132A-C and execution data 134A-C may be pushed by platforms 104A, 104B and 108A, 108B to data collection module 122 through network 110, or it may conversely be pulled by data collection module 122 from platforms 104A, 104B and 108A, 108B via network 110, or a combination of both push and pull schemes may be employed.

Obviously it is also possible for broker analysis module 124 to ask data collection module 122 for pricing data 132A-C and execution data 134A-C on an on-demand or as-needed or pull basis. Such an ask/request then triggers a data collection cycle by data collection module 122, or alternatively data collection module 122 may provide pricing data 132A-C and execution data 134A-C to broker analysis module 124 at the conclusion of a data collection cycle, on a periodic or as-needed basis. Furthermore, pricing data files 132A-C may all be combined into a single file, and execution data files 134A-C may be combined into a single file. Further still, pricing data files 132A-C and execution data files 134A-C may all be combined into a single file. As will be apparent to those skilled in the art of computer system design and architecture, there are many alternative ways to design and architect broker evaluation system 100 and its various modules and components, within the scope of the present invention, and while several embodiments are explained in detail for illustrative purposes, the invention admits of having alternative configurations within its scope that are not delved into detail in this specification, and may be readily recognized as practicable by one skilled in the art.

For example, it is entirely possible to decompose data collection module 122 into two sub-modules, one module for collecting data from live trading accounts from platforms 104A, 104B and 108A, 108B, and another module for collecting data from demo trading accounts from platforms 104A, 104B and 108A, 108B. An alternative configuration could employ one type of data collection module for collecting pricing data files 132A-C and another type of data collection module for collecting execution data files 134A-C. Still an alternative configuration could decompose broker analysis module 124 into sub-components as desired to achieve one's architectural goals. Such techniques are well understood in the field of computer architecture and design.

Before proceeding further, it will be helpful for us to define certain commonly used investment terms of the financial industry, as they will be applied to various embodiments of the present invention in the ensuing specification.

Pip: A pip is a standardized unit and is the smallest amount by which a currency quote can change, which is usually 0.0001 USD for U.S. dollar related currency pairs, and is also commonly referred to as 1/100th of 1%, or one basis point.

Spread: Spread is the difference between the Bid and Ask price of a financial asset offered by a broker.

Swap: In the OTC market, a swap means the price for moving or ‘carrying’ an open trading position to the next trading day. Depending on the financial asset or trading instrument being traded in the open position, the swap can be either positive or negative. In other words, depending on the movement of the market for the financial asset being traded, a trader may have to pay the broker, sometimes referred to as ‘swap paid’, for moving his/her open position to the next trading day, or alternatively he/she may be paid by the broker, sometimes referred to as ‘swap received’, for moving his/her open position to the next trading day.

Commission: Commission is the fee charged by the broker for the executed transactions.

Slippage: Slippage is the difference between the price at which an order is placed, and the price at which it is actually filled. Slippage is important because it affects the true transaction cost of trading, together with spreads, swaps, and commissions. While slippage usually has an adverse effect on transaction cost, based on the movement in the price of the financial asset being traded, some brokers offer what is known as price improvements or positive slippage.

Price re-quote: A Price re-quote, or simply a re-quote, occurs when after placing an order at a certain price, the trader gets the order re-quoted at a different price by the broker. This is because, during the time an order is submitted or placed, and at the point in time just prior to its execution in the broker's system, sometimes referred to as broker's book, the market has already moved, so the broker offers the trader a new price. Re-quotes are often observed during high volatility periods of the market, such as during major economic news publications.

Price reject: A price reject, or simply a reject, is similar to a price re-quote except that based on the movement of the market between the placement or submission of the order and at the point in time just prior to its execution, based on the movement of the market, the broker may simply reject the order and not offer an alternative price.

Latency: Latency is defined as the delay in time between the actual price of the asset being traded in broker's book and when that price is seen in the trading platform of the trader.

Other terminology: Note that in the ensuing specification, we may refer to a user, a trader and a client interchangeably and only draw a distinction between these terms as and when necessary. Sometimes a client may also refer to a software or an automated trading client (i.e. a robot), that is not necessarily being operated by a human being. Similarly we may use the terms trading station, trading platform and trading terminal interchangeably. By a trading station/platform/terminal we mean the broker dependent or broker provided or broker supported system or software that a user/trader/client uses for performing trades with that specific broker. An example of a trading platform is MT4 which is supported by a wide variety of brokers. Brokers may also provide their own trading terminals or web-based software for users to conduct their trading activities in. Further in this specification, we may also use the terms asset, security or instrument interchangeably for designating any type of financial asset being traded.

Armed with the above knowledge of the familiar terms of the investment and financial industry, let us turn our attention back to FIG. 1 illustrating broker evaluation system 100 of the present invention. Recall that according to the main embodiment of the instant invention, online broker evaluation system 100 evaluates online brokers 102A-C based on broker-scores 130A-C computed for each online broker 102A-C. Each such broker-score 130A, 130B, 130C for an online broker 102A, 102B, 120C is further comprised of a pricing-score score 126A, 126B, 126C and an execution-score 128A, 128B, 128C respectively. Pricing-scores 126A-C and execution-scores 128A-C are further based on pricing data 132A-C and execution data 134A-C of corresponding online brokers 102A-C respectively.

Preferably, a broker-score 130A of an online broker 102A is computed as a summation of its pricing-score 126A and execution-score 128B. In other words:

Broker-score_{A}=Pricing-score_{A}+Execution-score_{A}. (1)

Similarly for online brokers 102B, 102C:

Broker-score_{B}=Pricing-score_{B}+Execution-score_{B}, (2)

Broker-score_{C}=Pricing-score_{C}+Execution-score_{C}. (3)

As already stated, the invention admits of any number of such online brokers for evaluation by above scheme, therefore more generically for any broker i,

Broker-scoreᵢ=Pricing-scoreᵢ+Execution-scoreᵢ. (4)

In the preferred embodiment, broker-score is a function of pricing-score and execution-score as taught above, and is computed for 1 million USD traded for Forex or currency trading transactions. In other words, the invention standardizes or normalizes the scores based on a given transaction size, which may actually be executed in reality, or simply extrapolated by calculation. The standard/normalized size of the transaction according to the invention is 1 million USD for Forex or currency trading. Of course, any alternative size of a normalized or standardized transaction is possible for the computation of the various scores (broker-score, pricing-score, execution-score), within the scope of the invention.

Preferably, broker-scores 130A-C that are computed by the instant invention are specific to a particular financial asset or security being traded by brokers 102A-C. That is because the pricing and execution parameters of an online broker generally vary according to the type of financial asset being traded, and also according to the platform that it is being traded on. In other words, the same online broker who may be brokering Forex and stocks, may have two different broker-scores computed by online broker evaluation system 100 of FIG. 1. Obviously, in such a scenario, broker-scores 130A-C may further consist of pricing-scores 126A-C and execution-scores 128A-C that are specific to that financial asset. Furthermore, pricings-scores 126A-C and execution-scores 128A-C may further be based on pricing data 132A-C and execution data 134A-C that is also specific to a given financial asset being traded.

In other words, Equations 1-4 above may be re-written as:

Broker-score_{A(Forex)}=Pricing-score_{A(Forex)}+Execution-score_{A,(Forex)},

Broker-score_{B(Forex)}=Pricing-score_{B(Forex)}+Execution-score_{B,(Forex)},

Broker-score_{C(Forex)}=Pricing-score_{C(Forex)}+Execution-score_{C,(Forex)},

Broker-score_{i(Forex)}=Pricing-score_{i(Forex)}+Execution-score_{i,(Forex)}.

Similarly,

Broker-score_{A(Stocks)}=Pricing-score_{A(Stocks)}+Execution-score_{A,(Stocks)},

Broker-score_{B(Stocks)}=Pricing-score_{B(Stocks)}+Execution-score_{B,(Stocks)},

Broker-score_{C(Stocks)}=Pricing-score_{C(Stocks)}+Execution-score_{C,(Stocks)},

Broker-score_{i(Stocks)}=Pricing-score_{i(Stocks)}+Execution-score_{i,(Stocks)}.

As mentioned above, broker-scores 130A-C of online brokers 102A-C as computed by the instant invention embodied in FIG. 1, can also be dependent on the specific trading platforms 104A, 104B and 108A, 108B, that are used for trading with brokers 102A-C. This is because, pricing and execution parameters of an online broker vary according to the financial asset being traded, but they may also vary according to the trading platform that they are traded on. That is especially true for execution parameters because of the various technical dependencies of the broker systems on the trading platforms they support. Known to people with ordinary technical skills, these dependencies are not the focus of the instant invention, and will be not be delved into detail in this specification.

Taking both the asset/security and platform dependencies into account and assuming as an example, our trading platform to be MT4 for which brokers-scores 130A-C in FIG. 1 are being computed, Equations 1-4 may be re-written as follows:

Broker-score_{A(Forex,MT4)}=Pricing-score_{A(Forex,MT4)}+Execution-score_{A,(Forex,MT4)}, (5)

Broker-score_{B(Forex,MT4)}=Pricing-score_{B(Forex,MT4)}+Execution-score_{B,(Forex,MT4)} (6)

Broker-score_{C(Forex,MT4)}=Pricing-score_{C(Forex,MT4)}+Execution-score_{C,(Forex,MT4)} (7)

Broker-score_{i(Forex,MT4)}=Pricing-score_{i(Forex,MT4)}+Execution-score_{i,(Forex,MT4)}. (8)

Similarly,

Broker-score_{A(Stocks,MT4)}=Pricing-score_{A(Stocks,MT4)}+Execution-score_{A,(Stocks,MT4)} (9)

Broker-score_{B(Stocks,MT4)}=Pricing-score_{B(Stocks,MT4)}+Execution-score_{B,(Stocks,MT4)} (10)

Broker-score_{C(Stocks,MT4)}=Pricing-score_{C(Stocks,MT4)}+Execution-score_{C,(Stocks,MT4)} (11)

Broker-score_{i(Stocks,MT4)}=Pricing-score_{i(Stocks,MT4)}+Execution-score_{i,(Stocks,MT4)}. (12)

### Pricing-Score:

Referring still to FIG. 1, in the preferred embodiment, pricing data 132A-C used for determining pricing-scores 126A-C comprises the size of the spread for the asset being traded, the commission being charged by online brokers 102A-C and the swaps being paid or received by traders 106A, 106B at trading platforms 104A, 104B, or by the accounts associated with unmanned or automated trading platforms 108A, 108B. Note, that even though trading platforms 108A, 108B may be automated and unmanned, there will still be a user account associated with trading on these platforms, and it is this account that the spread, commission and swaps may be applied to by online brokers 102A-C as explained above.

Specifically, pricing-score 126A-C of online brokers 102A-C, for a given financial asset being traded and for a given trading platform, is expressed by the following equation:

Pricing-score=(Spread×Effective Quantity)+Commission+Swap, (13)

where Effective Quantity is dependent on the type of the asset or financial security being traded. For Forex trades, it is the average cost per pip for a 1000,000 USD trade. For other securities it is simply the number or quantities of the security being traded.

Specifically, for a EUR/USD Forex trade, Effective Quantity in Equation 13 above will be 100 USD, because the price of 1 pip is 10 USD i.e. 100,000 USD (standard lot size)/0.0001, and for a normalized/standardized trade size of USD 1000,000 per above explanation, Effective Quantity=10×10 USD=100 USD. If the quote currency is different from USD, then a currency conversion needs to be performed at the prevailing exchange rate to calculate the equivalent of 1000,000 USD Forex trade size to determine Effective Quantity.

For stocks and bonds, it is the number of shares or bonds being traded, for options, it is the number of contracts, for commodities and their futures, it is the number of bushels, etc. In other words, other than Forex where Effective Quantity in Equation 13 refers to the average cost per pip of the equivalent of a 1000,000 USD trade size, Effective Quantity otherwise refers to the actual quantity of the financial security being traded, in the typical contract size or unit of measure that it is traded in.

There are many alternative options of computing pricing-score 126A-C. For example, one approach can be to compute pricing-score 126A-C as a sum of the spread, commission and swap—all normalized for the amount of equity traded. By the amount of equity traded we mean the amount (as expressed in US dollars or another convenient currency) traded in the transaction, given by the number of financial assets traded multiplied by the average price of the security traded in the transaction. One can devise various ways of computing pricing-score that are a function of the spread, commission and swap within the scope of the invention. It is also entirely conceivable to base pricing-score on other pricing parameters, in addition to or including spread, commission and swaps, pertaining to online brokers and the asset being traded. Indeed the pricing parameters as reflected in pricing data 132A-C collected by data collection module 122 of FIG. 1, may also be dependent on the sophistication of the brokerage services offered by online brokers 102A-C and complexity of trading platforms 104A, 104B and 108A, 108B where the data is captured by relevant modules of the respective platforms and then ultimately transferred to data collection module 122 of broker assessment module 120.

### Execution-Score:

In the preferred embodiment of the present invention, and referring still to FIG. 1, execution data 134A-C on which execution-scores 128A-C of online brokers 102A-C respectively are based, comprises average volatility and the price of a unit of the financial asset being traded.

By volatility we simply mean the difference in the highest and the lowest Bid price of the asset during the timeframe between when a trade by a trader (such as 106A, 106B or an automated client trading at stations/platforms 104A, 104B and 108A, 108B) was placed with an online broker 102A-C, and when it was executed at that same online broker 102A, 102B or 102C. Average volatility is obtained by dividing volatility by the number of seconds of time delay associated with the trade. By time delay here, we mean the time elapsed between the placement of the trade, and the time at which that trade was actually executed by that broker. By price of a financial asset being traded, we mean the price at which the asset was being offered by the online broker, and the unit that it was being offered in, at the time the trade was placed.

Preferably, execution scores 128A-C of each online broker 102A-C, for a given financial asset being traded and for a given trading platform, are computed using the following equation:

Execution-score=Effective Quantity×Average volatility (14)

where Effective Quantity has the meaning as explained above in reference to Pricing-score above.

Now let us take a few examples of using the above teachings of the instant invention to compute the broker-score of an online broker in FIG. 1. We will assume that in the below examples, the broker-score being computed is specific to a specific trading platform, such as MetaTrader 4 or MT4.

### Example 1

A Forex BUY trade of EUR/USD pair for a standard lot of 100,000 base currency (EUR) is submitted/placed by trader 106A at trading station/platform 104A at 11:45:53 GMT Dec. 3, 2014 with online broker 102B and (because of network delay on the computer network at broker 102B, re-quotes or rejects as explained earlier) the trade was executed by online broker 102B at 11:45:56 GMT Dec. 3, 2014. That means there was a time delay of 3 seconds.

Let us first compute the pricing-score for online broker 102B of FIG. 1. Assume for this example that online broker 102B has a spread of 2 pips and charges no trade commission. Also assume that it was an intra-day trade, so no swaps were applied. Per above explanation, the Effective Quantity or average cost per pip for a 1000,000 USD trade would be 100 USD. According to Equation 13 above:

Pricing-score=(Spread×Effective Quantity)+Commission+Swap=2×100 USD+0+0=200 USD

Let us further assume that the volatility, or the difference in the highest and lowest Bid price of EUR/USD pair during the above 3 seconds of delay, i.e. the time when the trade or order was initially placed, and when it was executed, was 10 pips. Then average volatility is 10 pips/3 seconds=3.3333, and therefore, according to Equation 14:

Execution-score=Effective Quantity×Average volatility=100×3.3333=333.33 USD

Consequently, as per Equation 6 above:

Broker-score_{102B(Forex,MT4)}=200 USD+333.33 USD=533.33 USD

### Example 2

Let us extend Example 1 above, and also assume that online broker 102B charges a commission of 10 USD per standard lot (100,000 USD), and assume that the trade was carried over to the next day where a swap of 0.013 USD was applied by online broker 102B. Then according to Equation 13 above:

Pricing-score=(Spread×Effective Quantity)+Commission+Swap=(2×100 USD)+10+0.013=210.013 USD

Consequently, as per Equation 6 above:

Broker-score_{102B(Forex,MT4)}=210.013 USD+333.33 USD=543.34 USD

### Example 3

Let us use another asset such as stocks. Let us assume that trader 104B of FIG. 1, submitted a market order to online broker 102C to BUY 100 shares of Apple Inc. at 130.06 USD per share on Feb. 26, 2015 at 15:35:40 GMT. The order was executed at online broker 102C at 15:35:42 GMT (2 seconds later) at the price of 130.36 USD. A commission of 0.015 USD per share was charged by online broker 102C, totaling to 0.015×100 shares=1.5 USD for the trade.

Let us further assume that the volatility i.e. the difference between the highest and lowest Bid price during the 2 seconds time delay, was 1 USD. So the average volatility was ½=0.5. Let us assume that the spread of Apple shares as quoted by online broker 102C was 0.18 USD per share.

Then according to Equation 13 above:

Pricing-score=(Spread×Effective Quantity)+Commission+Swap=(0.18×100)+1.5+0=19.5 USD

Further, from Equation 14 above:

Execution-score=Effective Quantity×Average volatility=100×0.5=50 USD

Consequently, from Equation 11 above:

Broker-score_{102C(Stocks,MT4)}=19.5 USD+50 USD=69.5 USD

While pricing-scores, execution-scores and the overall broker-scores as determined in the above examples are computed for individual transactions. In order to produce an overall score for a broker across potentially dozens, hundreds, thousands or even more transactions, the invention preferably utilizes convenient statistical averaging and normalization techniques known in the art to aggregate the above broker scores across the entire transaction set. Therefore, preferably, assuming i is the number of transactions:

Pricing-score=Σᵢ pricing-scores/i, (15)

Execution-score=Σᵢ execution-scores/i. (16)

Similarly Equations 1-14 can be updated as needed to accommodate any convenient statistically averaging across all transactions.

Preferably, online broker evaluation system 100 produces a list of online brokers 102A-C(and others), ranked according to their broker-scores as taught by above exemplary teachings. The ranking preferably includes additional ranking pivots/columns, such as including but not limited to, pricing-score, execution-score, spread, commission, swap, average volatility, time delay, slippage, etc. This generalized ranked list, is further preferably customized/personalized, according to the trading habits/profiles of individual traders 106A, 106B in FIG. 1. Finally the customized ranked list with various pivots and visualization features is presented to the individual traders 106A, 106B by online broker evaluation system 100 of FIG. 1.

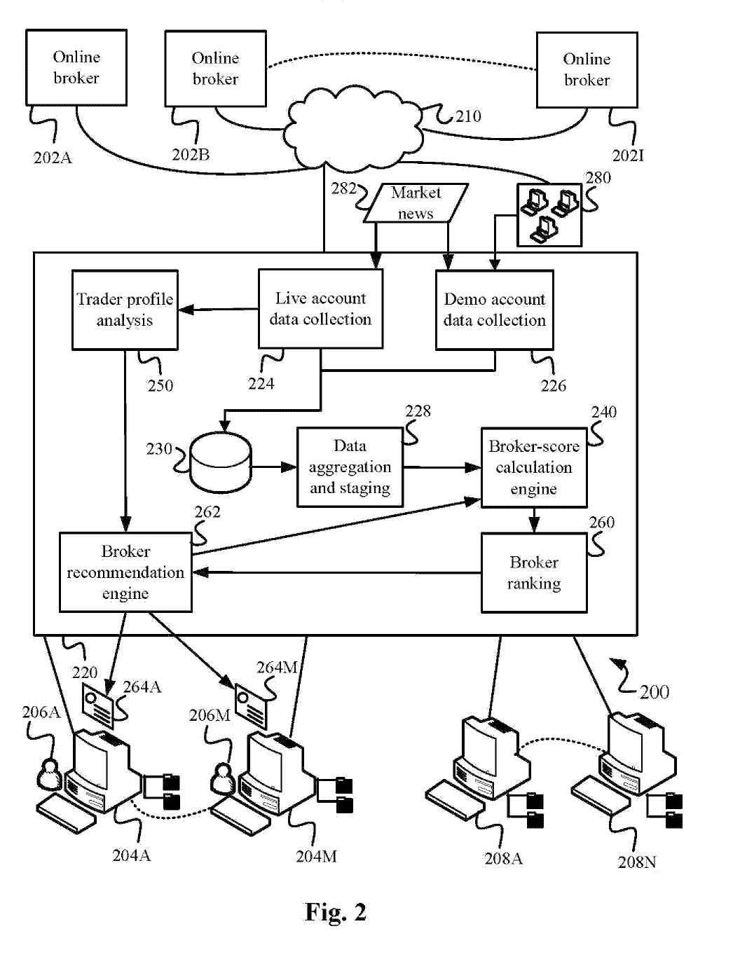

Let us turn to FIG. 2 illustrating a set of embodiments of the instant invention. Online broker evaluation system 200 of Fig. depicts a number of online brokers 202A, 202B . . . 202I, a number of traders 206A . . . 206M and their associated trading platforms/stations/terminals 204A . . . 204M as well as unmanned or automated trading platforms/stations/terminals 208A . . . 208N. As explained before, trading platforms 204A . . . 204M may be executing manual or automated trading strategies while platforms 208A . . . 208N are presumed to be executing automated trading strategies.

As before, platforms 204A . . . 204M and 208A . . . 208N may be executing live or demo accounts. Online brokers 202A . . . 202I may be brokering one or more OTC financial securities or instruments, including but not limited to stocks, bonds, commodities, futures, forwards, swaps, options, debentures and foreign exchange (Forex or FX) or currency trading. Similarly, online trading platforms 104A . . . 104M and 108A . . . 108N may include, but are not limited to, MetaTrader 4 (MT4), MetaTrader 5 (MT5), CTrader, ActTrader, Trader Workstation (TWS) and any other Application Programming Interface (API) enabled trading platform. TWS is supported by the popular brokerage company Interactive Brokers. An API associated with a trading platform enables the present invention to extend the platforms capabilities to include custom modules or expert advisors as will be taught below.

Online broker evaluation system 200 of the present invention as illustrated in FIG. 2, also comprises a broker assessment module 220 as shown. Online brokers 202A . . . 202I are connected to broker assessment module 220 of system 200 via network 210, which is preferably the internet but could be any other suitable local or wide area network. Similarly trading platforms 204A . . . 204M and 208A . . . 208N are connected to broker assessment module 220, and to online brokers 202A . . . 202I via network 210. Note that for clarity we have omitted network 210 as being the connectivity network between platforms 204A . . . 204M and 208A . . . 208N and online brokers 202A . . . 202I as well as broker assessment module 220 of the instant invention, but it is understood to be present. Likewise, in the ensuing explanation, while referring to the connections between various modules depicted in FIG. 2, we will omit references to network 210 for clarity, with the understanding that such connections will be provided via network 210. Such a conventional omission of a pervasive network, such as the internet, is common in technical diagrams and architectural writings, as will be recognized by those skilled in the art.

Broker assessment module 220 of the instant invention as shown in FIG. 2, further comprises a live account data collection module 224 that collects pricing and execution data pertaining to online brokers 202A . . . 202I from live accounts running on trading platforms 204A . . . 204M and 208A . . . 208N. Similarly, there is also a demo account data collection module 226 that collects pricing and execution data from demo accounts that may be running on trading stations/platforms 204A . . . 204M and 208A . . . 208N, as well as an automated demo station group 280. Again, it is a matter of architectural design and convenience whether pricing and execution data may be collected by a single module or by two separate modules, or whether live and demo data may be collected by a single data collection module or separate modules, as well as whether data is collected on an on-demand, push, pull, real-time or batch basis—as will be recognized by those skilled in the art. The apparatuses and methods of present invention are not restrictive of a particular technical design for accruing its benefits, features and capabilities.

Pricing and execution data collected by live account data collection module 224 and demo account data collection module 226 is stored in a datastore/database 230 as shown in FIG. 2. In addition, other trade/transactional and historical data relating to the trading operations of traders 206A . . . 206M may also be stored in database 230, as will be further taught below. Again many technical design choices exist when it comes to choosing or designing such a database, including various open-source and commercial database choices. Such considerations are well understood in the art and will not be delved into detail in this specification.

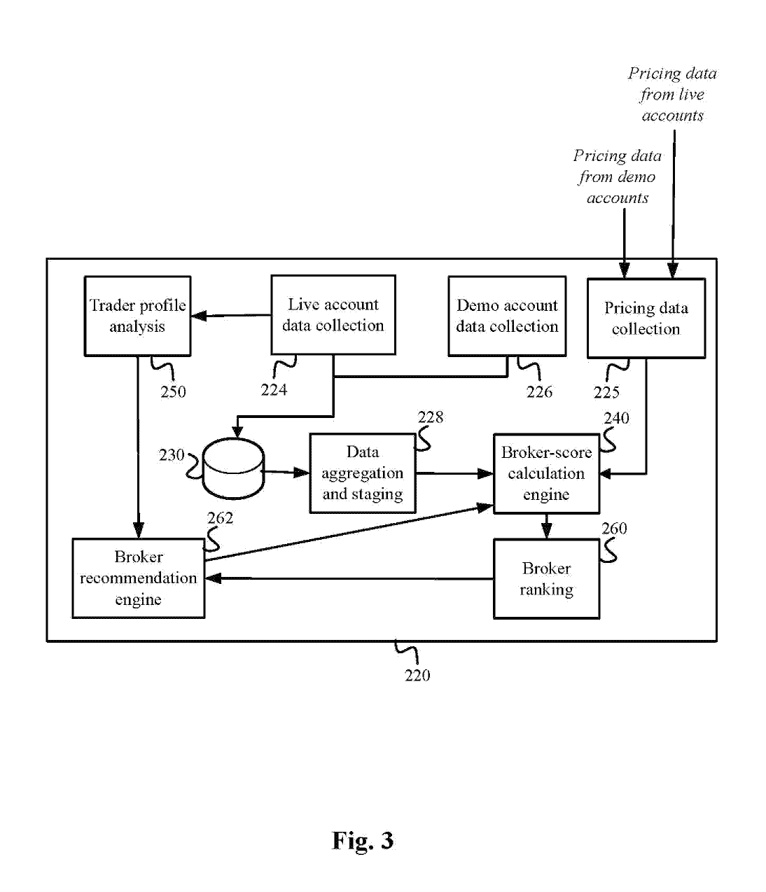

As mentioned above, the invention admits of several architectural and design variations known to people with skills in computer design and architecture, besides the specific embodiments illustrated in the figures. Hence in an exemplary variation of broker assessment module 220 of FIG. 2, data collection functions are separated such that live and demo account data collection modules 224 and 226 respectively collect execution data, while a separate pricing data collection module is provided. This variation is illustrated it in FIG. 3, where pricing data collection module 225 is responsible for collecting pricing data from demo accounts as well as live accounts as illustrated by the corresponding inbound arrows to pricing data collection module 225 in FIG. 3. Specifically, pricing data collection module 225 receives pricing data from demo accounts at demo station group 280 and live accounts at terminals 204A . . . 204M and 208A . . . 208N shown in FIG. 2. Additionally, pricing data collection module 225 may also receive pricing data from any demo accounts running at terminals 204A . . . 204M and 208A . . . 208N of FIG. 2. Note that in FIG. 3 we have just shown broker assessment module 220 of FIG. 2 in detail, while omitting rest of the components from FIG. 2 for clarity.

Database 230 may itself comprise of multiple databases or datastores, each responsible for housing a given type of data, e.g. one datastore/database for storing live trading data, another datastore/database for storing demo trading data, etc. As per above explanation, once pricing and execution data has been collected in database 230, it is then harnessed by a data aggregation module 228 that massages it, prepares it and stages/presents it to a broker-score calculation engine 240. There is also one or more market newsfeeds 282 provided to live and demo account data collection modules 224 and 226 respectively of FIG. 2 and FIG. 3. The functionality of market newsfeeds 282 will be explained in the ensuing explanation further below.

Trading platforms, stations or terminals of automated demo station group 280 of system 200 are responsible for executing automated strategies or robots for collecting data from brokers 202A . . . 202I on demo accounts. Because at the initial launch of broker evaluation system taught by the present invention, there may not be enough live and historical data to perform comprehensive analysis of brokers 202A . . . 202I, demo station group 280 provides a convenient tool to garner pricing and execution data pertaining to various financial instruments from brokers 202A . . . 202I without incurring real transactional costs. Furthermore, during the normal course of operation of system 200, data collected from demo station group 280 is also regularly compared with data collected from live accounts to highlight any deviations that would demonstrate if any online broker(s) are misleading customers by showing them more preferable trading terms in their demo account versus their live accounts.

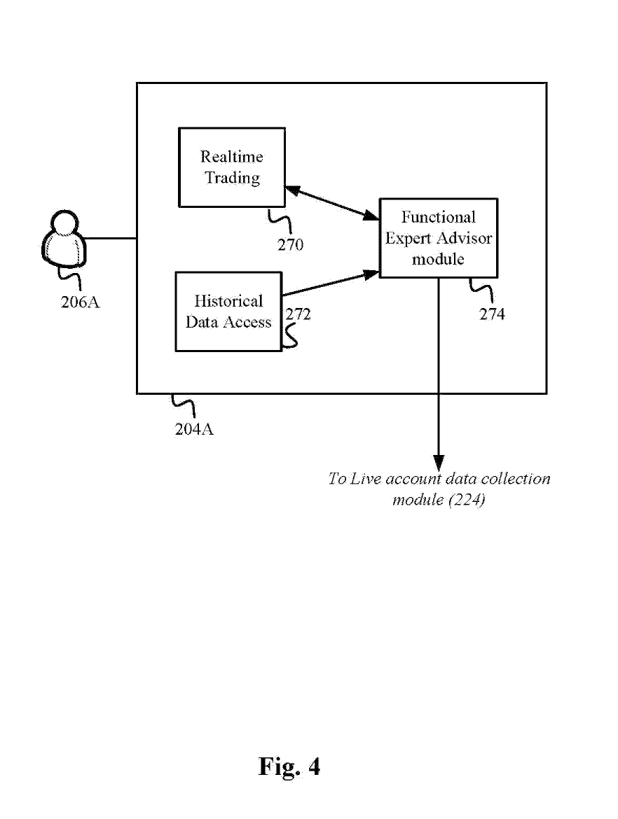

FIG. 4 shows an exploded view of a trading platform 204A associated with trader 206A. Trading platform 204A of trader 206A generally comprises a real-time trading module 270 that is responsible for operationally enabling trader 206A to perform trades with an online broker (not shown in FIG. 4), a historical data access module 272 allowing access to historical trade activity of trader 206A, and other modules (not shown) as may be technically needed for trading operations at trading platform 204A. Trading platform 204A also generally provides a mechanism to extend its functionality with custom post and preprocessing logic. Such a mechanism is generally known as a custom Expert Advisor (EA) of trading platform 204A.

The present invention requires the installation of such a custom EA module 274, referred to as Functional EA module 274, which is responsible for the requisite interception of trading operations of trading platform 204A (specifically its real-time trading module 270), for the collection of pricing and execution data necessary for the computation of the various metrics related to online brokers 202A . . . 202I (see FIG. 2). Specifically, these metrics include pricing-score, execution-score and the overall broker-score of each broker, as per above teachings. As will be apparent, the present invention leverages live trading data from actual traders 204A . . . 204M (see FIG. 2) registered with online broker evaluation system 200 for broker analysis. The alternative option of generating live trading data using custom EA modules or other robots in order to sufficiently seed/populate system 200 and specifically database 230 with live trading data will, of course, be much costlier.

Those familiar to MetaTrader trading platforms (MT4, MT5) will readily recognize the popular capability of such platforms to allow the development of a custom EA. However the concept of custom scripting or an alternative method of providing a preprocessing and postprocessing logic extend to a variety of other trading platforms and as such the present invention will be implemented in those other trading platforms according to their Application Programming Interface (API) capabilities for custom programming/scripting provided by such platforms. Referring to FIG. 4, once the necessary data has been collected by Functional EA module 274 from real-time trading module 270, it is then transmitted to live data collection module 224 of FIG. 2.

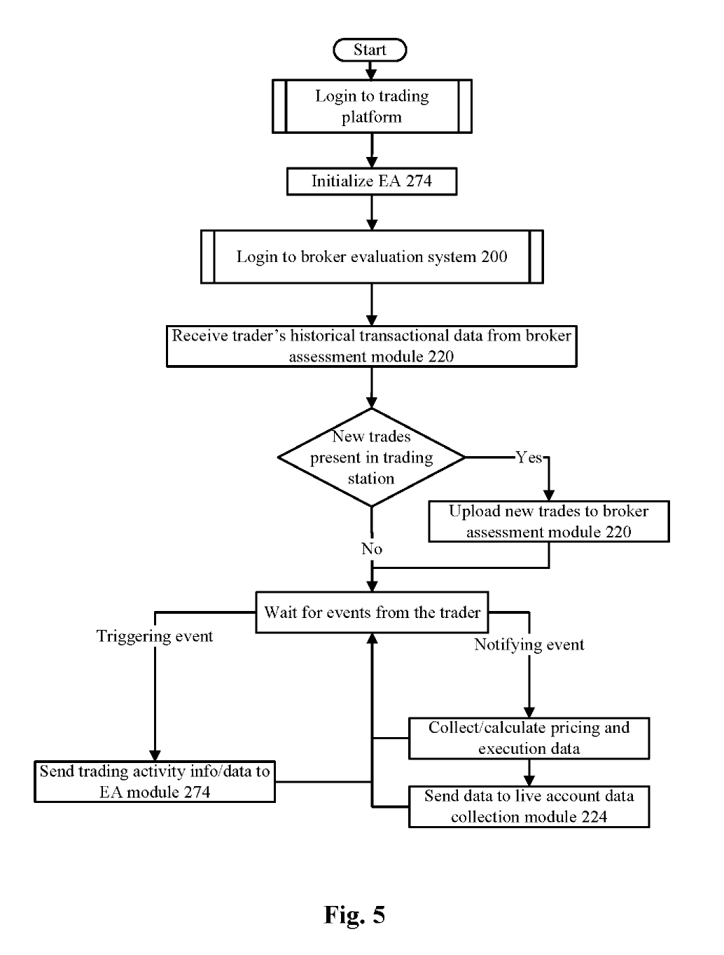

FIG. 5 depicts in a flowchart form the various steps required for the operation of broker evaluation system 200 presented in FIG. 2, including the variation having a modified broker assessment module 220 shown in FIG. 3. As such, we will be referring to FIG. 2-5 collectively in the ensuing explanation. A trader, e.g. 206M of FIG. 2, first logs into trading platform/station 204M correspondent to one of online brokers 202A . . . 202I, where he/she intends to execute a trade for a given financial instrument, e.g. Forex. As a part of the installation of broker evaluation system 200, Functional EA module 274 would have already been installed and registered with trading platform 204M.

Upon successful login of trader 206M in trading platform 204M, trading platform 204M initializes Functional EA module 274. Then Functional EA module 274 connects with and logs into broker evaluation system 200 and performs authorization with the credentials of trader 204M. Obviously it is assumed that trader 206M has valid registration and login/authorization credentials with the appropriate broker as well as with broker evaluation system 200 of the present invention. Note that broker evaluation system 200 may be offered as a service over the internet to online traders. Such a service may be offered as a 3^{rd}. party, objective and impartial service for the assessment of online brokers for various financial securities for the benefit of traders globally.

Soon after the login and authorization process performed by Functional EA module 274 on behalf of trader 206M with broker evaluation system 200, any previous transaction history of trader 206M as stored in broker assessment module 220 is downloaded. If there are any new trades in trading station/platform 204M for trader 206M that are not a part of the previous transaction history as downloaded, the new trades are uploaded to the broker assessment module 220. Then EA module listens or waits for a ‘triggering event’ or a ‘notifying event’ by trader 206M. A triggering event can be any operational trading event, including initiation of a new trade, completion of a trade, cancellation of a trade, modification of a trade, quote request, etc.

Such triggering events are either intercepted by Functional EA module 274 and the pricing and execution data related to the trading activity of trader 206M is collected by Functional EA module 274, or trading station/platform 204M simply passes the pricing and execution data related to the trading activity of trader 206M upon the occurrence of a triggering event on to Functional EA module 274. Recall that Functional EA module 274 is registered with trading station/platform 204M and which knows its purpose and requirements, and therefore can easily pass information to it. Additionally, upon the reception of a special type of event, i.e. a ‘notifying event’, Functional EA module 274 collects/calculates certain data elements and transmits them to live account data collection module 224. Such notifying events include, the initiation of a new trade, and the closing of an existing trade, and the data elements collected/calculated include:
Start/end times of the trade. Such timing information is kept by Functional EA module 274 via an internal timer which starts when trader 206M places an order for execution and stops upon response from the broker. EA module also performs ping requests to the broker server on a regular basis (1-2 mins) and collects information about network delay. This network delay is accounted for while calculating the start/end times of the trade.
Stock/pair symbol used in the trade
Asked price for the trade
Slippage incurred in the trade
Commission charged by the broker, etc.

For completeness, Table 1 below depicts a more comprehensive but non-exhaustive list of data fields and their corresponding values in an implementation of the present invention, as captured by Functional EA module 274 and transmitted to live account data collection module 224.

TABLE 1

| Field name | Value |
|---|---|
| Terminal name | MT4 |
| Order execution type | Instant or Market |
| Order submit timestamp | Wed, 10 Dec 2014 00:11:22.128 |
| | GMT |
| Order executed timestamp | Wed, 10 Dec 2014 00:11:24.608 |
| | GMT |
| Instrument | EUR/USD |
| Order Size (in base currency units) | 100,000 |
| Position type | Long or Short |
| Order type | Market Order or Limit Order |
| BID price at the moment of order | 1.23868 |
| submission | |
| ASK price at the moment of order | 1.23898 |
| submission | |
| BID price at the moment of order | 1.23898 |
| execution | |
| ASK price at the moment of order | 1.23801 |
| execution | |
| Order submission price | 1.28868 |
| Order executed price | 1.23898 |
| Slippage size | 3 pip |
| Slippage positive (in favor of client) | no |
| Slippage negative (in favor of broker) | yes |
| Re-quote (if the price was re-quoted) | no |
| Price reject (if the price was rejected) | no |
| SWAP | 0 pip |
| Broker Commission | 0 USD |
| Network delay | 145 ms |
| Broker delay | 100 ms |

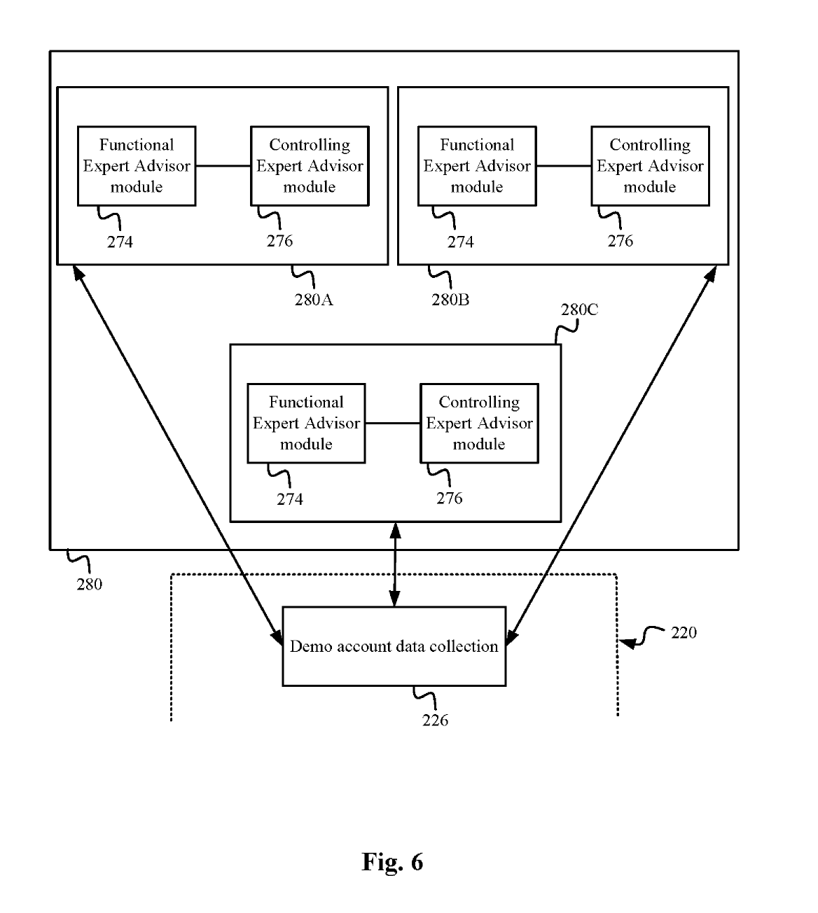

FIG. 6 shows the functioning of demo station group 280 and data collection module 226 of FIG. 2. Each trading station/platform 280A, 280B, 280C in demo station group 280 performs similarly to trading stations/platforms 204A . . . 204M and 208A . . . 208N explained above, however with some major differences. One difference is that each trading station/platform 280A-C in demo station group 280 is configured to automatically connect, upon system start, to a preconfigured set of online brokers and execute demo trades at the request of demo account data collection module 226, as will be further explained below. The preconfigured set of online brokers may be a subset of overall online brokers 202A . . . 202I or these may be all of them.

Furthermore, the demo accounts used by demo station group 280 may be configured for some financial instruments or for all of them. Also, demo station group 280 may be running demo platforms/stations/terminals of some subset of online brokers 202A . . . 202I or all of them. The demo accounts of demo station group 280 are initially loaded with a demo account balance. Once the demo account balance of a demo account reaches a low enough level, the broker evaluation system 200 issues an administrator alert to update the demo account balance or to replace the old demo account with a new one.

When online broker evaluation system 200 of FIG. 2 starts, each trading station 280A-C connects with and logs into its preconfigured set of online brokers as explained above. It does this by utilizing the proper trading terminal software or broker system required for a given broker and using a corresponding demo account also preconfigured for the broker. The information related to the preconfigured set of online brokers, their demo accounts along with the account credentials is preferably stored in a separate database/datastore or in a separate set of tables in database 230. This information is generally populated manually and updated periodically by the administrator of system 200 when demo accounts either expire or run out of available credits.

Once one or more trading station/platform 280A, 280B, 280C of demo station group 280 has automatically connected with and logged into a broker system, the trading station/platform initializes two custom Expert Advisors. One of them is a

Functional EA 274 as explained in above teachings in reference to collecting live accounts data. The other is a Controlling EA 276 as shown in FIG. 6. The purpose of Controlling EA 276 is to enable automated execution of trading transactions initiated by demo account data collection module 226. These transactions are initiated by demo account data collection module 226 based on qualifying events.

Such qualifying events include significant market news, or publication of important market data (e.g. non-farm payroll), or any other significant event occurring in the financial industry. One skilled in the art will recognize that financial/market events can be easily discovered by demo account data collection module 226 by consulting one or more appropriate newsfeeds 282 (see FIG. 2). A popular example of such a newsfeed is the economic events calendars from Fxstreet.com (http://www.fxstreet.com/economic-calendar/). When a qualifying event occurs, demo account data collection module 226 sends a command to Controlling EA modules 276 of various trading stations/platforms 280A-C of demo station group 280, signaling them to execute a trading action, appropriate to the qualifying event. The trading action can be any trading activity, such as, initiating a new trade, updating an existing trade, closing an existing trade, canceling an existing trade, etc. When a trading station/platform, e.g. 280B, executes the requested action, Functional EA module 274 captures the various metrics related to the trading activity in response to triggering events as taught above, and upon the occurrence of a notifying event, such as initiating/closing of a trade, passes collected/calculated data to the demo account collection module 226 of broker assessment module 220.

In order to minimize the losses in the demo account and extend the life of their demo account balances, if allowed by the corresponding brokers, two equal and opposing trades are opened simultaneously in the trading station/platform 280A-C (e.g. one to Buy and one to Sell) for each financial instrument for which trading stations/platforms 280A-C are configured to generate data. This way their accounts do not take a big loss regardless of the market movement. Placing two opposite trades also has the benefit of collecting data for the two opposing sides of a single trade, and hence further strengthening the quality of trading data used for broker analysis according to above teachings.

Additionally, demo account data collection module 226 may also send a command to Controlling EA modules 276 of various trading stations/platforms 280A-C of demo station group 280, on an ad-hoc basis, signaling them to execute a trade. Typically, any trading position thus opened by a Controlling EA module 276 stays open for a period of 3 minutes, which gives sufficient time for pricing and execution data to be collected, without the market moving too far. In an exemplary embodiment of the invention, the data fields collected and transmitted by Functional EA module 274 of trading stations/platforms 280A-C and their corresponding values are shown above in Table 1.

In addition to the above mentioned functions of demo station group 280, demo station group 280 also performs another important task. It retrieves pricing data for demo account data collection module 226 of FIG. 2, as well as for pricing data collection module 225 of the variation shown in FIG. 3. When online broker evaluation system 200 of FIG. 2 starts and trading stations 280A-C have logged in and connected with their preconfigured online brokers as explained above, controlling expert advisor module 276 of each of terminals 280A-C starts to stream pricing update events for the preconfigured set of instruments traded by the preconfigured set of brokers, to demo data collection module 226 of FIG. 2, or to pricing data collection module 225 of FIG. 3. This price update stream is then prepared and stored in database 230 by demo data collection module 226 of FIG. 2 or by pricing data collection module 225 of FIG. 3. An example of such a pricing update event is shown below:

BrokerInstrumentUpdateEvent:
{
“brokerStringId”: “ForexClub”,
“symbolName”: “NZDUSD”,
“demoAccount”: true,
“bid”: 0.74796,
“ask”: 0.7482,
“spread”: 2.400279E−4,
“timestamp”: 1427775788
}

Such events are generated by controlling expert advisor module 276 in MT4 terminals and pushed either synchronously or asynchronously to module 226 or 225 as explained above. These events enable the establishment of a history of Bid/Ask price changes for all instruments across all brokers registered in the system. This information is then used to calculate average volatility for each transaction captured by live account data collection module 224 or demo account data collection module 226. This is the average volatility as used in Equation 14 and in the ensuing examples above. Furthermore, the pricing events streamed and stored in database 230 allow the determination of average volatility for various instruments for online brokers 202A . . . I of FIG. 2, on a historical basis. This is used in the historical analysis for determining the historical fit for online brokers for individual traders as will be taught below.

It should be noted that though currently only desktop-based trading stations/terminals support the installation of custom Expert Advisor (EA) modules, however whence such a support becomes available on mobile devices, the teachings of the instant invention can be immediately extended to the mobile devices. In other words, in such a future scenario, trading terminals 204A . . . 204M as well as 280A, 280B, 280C may be a combination of desktop and mobile trading stations. Obviously, any user interface developed for the embodiments taught by the instant invention is not restrictive of a given computing platform, whether desktop, mobile or otherwise. Even currently, however, if a particular broker offers Virtual Private Server (VPS) hosting service, then custom EA modules (Functional EA module 274 and/or controlling EA module 276 above) can be currently installed in VPS hosted environment. Then, traders/users 206A . . . 206M may access system 200 using their mobile devices. However, in such a scenario, time delays associated with remote VPS hosting will need to accounted for in the above calculation of broker metrics.

Now let us turn our attention back to FIG. 2. Obviously, the data manipulation/aggregation performed by data aggregation module 228 will be dependent on the technical and functional requirements of broker-score calculation engine 240. Generally, data aggregation and staging module 228 will aggregate pricing and execution data by each online broker 202A . . . 202I. Since various traders/users 206A . . . 206M may be using different online brokers 202A . . . 202I, for various financial assets, using various trading platforms and at various points in time, the pricing and execution data collected by live and demo account data collection modules 224 and 226 will comprise a variety of different relationships. It is the responsibility of data aggregation and staging module 228 to cleanse and aggregate this data in a consistent fashion by each online broker and according to each data attribute collected. Database schema design techniques for the required purpose are well understood in the art, and the present invention, its systems and methods, admit of various such design alternatives without deviating from its scope. For example, data aggregation and staging may be implemented via an Extract-Transform-Load (ETL) module associated with the database 230 itself.

Broker-score calculation engine computes the broker-scores of online brokers 202A . . . 202I as per above teachings. As also taught above, present invention performs a ranking of online brokers 202A . . . 202I. Such a ranking can be pivoted on various metrics and attributes, such as broker-score, pricing-score, execution-score, spread, commission, swap, average volatility, time delay, latency, slippage, etc. This ranking is performed by broker ranking module 260 shown in FIG. 2. Ranking thus produced is a generalized ranking of online brokers 202A . . . 202I, because it has not yet been customized for individual traders 206A . . . 206M, as will be explained further below.

Broker assessment module 220 of FIG. 2-3 also comprises a trader profile analysis module 250. Module 250 is responsible for analyzing the trading habits of traders 206A . . . 206M. Such an analysis preferably includes a historical analysis of various trading attributes of a trader, including:
Securities/instruments traded
Percentage of intra-day trades
Average position size per instrument
Number of trades per day
Average time a position stays open
Past spreads paid
Past commissions paid
Past swaps paid/received

Trader profile analysis module 250 then provides the results of its analysis to a broker recommendation engine 262 as shown in FIG. 2-3. Broker recommendation engine also takes as input the generalized broker ranking produced by broker ranking module 260. Based on the combination of the two, broker recommendation engine 262 produces a customized ranked list of recommendations 264A . . . 264M for traders 204A . . . 204M respectively.

It should be noted that pricing and execution data for a broker, e.g. 202B (see FIG. 2), at a given point in time, even for the same financial instrument and the same platform may vary between different traders. Therefore, in order to perform an overall analysis of online broker 202B for a given financial asset and platform, pricing and execution data needs to be collected and aggregated from all traders 206A . . . 206M. For computing broker recommendations for a given trader, e.g. 206M for a given financial instrument, e.g. bonds, for a given platform e.g. MT5, if there is live trading data available for trader 206M, recommendation engine provides its recommendations for online brokers 202A . . . 202I to trader/user 206M based on broker-scores of the online brokers, and preferably customized for trader/user 206M, per above teachings. If however no live trading data for bonds trading on MT5 for user 206M is available, recommendation engine uses extrapolation to determine broker recommendations for user 206M based on historical bonds trading data of trader/user 206M on MT5.

As another example, if historical trading analysis generated by trader profile analysis module 250 suggests that a trader 206A historically trades Microsoft (MSFT) stocks with 90% of trades as intra-day trades (implying that paying swaps for overnight carrying of trades is not a significant factor for trader 206A), using a typical position size of 100 shares as averaged over the last year, then based on this information, broker recommendation engine 262 will request broker-score calculation engine 240 to compute broker-scores for online brokers 202A . . . 202I who offer MSFT stock. Once broker-score calculation engine has computed broker-scores per above teachings, broker ranking module 260 generates/updates broker ranking and provides it to broker recommendation engine 262, which recommendation engine 262 may further customize based on the historical trading analysis for trader 206A provided by trader profile analysis module 250, and then presents the customized suggestions/ranking 264A of various brokers for MSFT trading to trader 206A.

It should be noted that broker-scores are computed for all brokers in the system that offer the same set of trading instruments selected by the user. In our example above, broker assessment module 220 will compute brokers-scores for bonds and MSFT for all available brokers 202A . . . 202I registered in the system. That is how broker ranking module 260 can generate its ranking and broker recommendation engine 262 can present its customized suggestions/ranking to the users. Obviously, for an accurate comparative analysis of the brokers, system 200 would compute brokers-scores under normalized settings or under ‘equal conditions’. For this purpose, the system would use well-known techniques such as interpolation, extrapolation, averages, predictions, etc. for appropriate computation of broker metrics as needed.

Recommendations 264A . . . 264M are presented to respective users 206A, 206B as a pivot table ranking of the brokers by various metrics depending on the set of filters selected by the user. Ranking thus produced, is the customized ranking of online brokers 202A . . . 202I for individual traders. There can be many different filters, including but not limited to the following:
Trading platform
Instrument
Account Type (Live/Demo)
Pricing-score
Execution-score
Broker-score
Spread
Commission size
Swap
Average volatility
Time delay
Latency
Slippage

Furthermore, as a part of the delivery of broker recommendations 264A . . . 264M, broker evaluation system 200 of the present invention may also provide a comparison of the various metrics of a broker as well as the overall ranked list as customized for an individual trader, e.g. 206A, against the same metrics and the overall ranked list for other traders 206B . . . 206M. That provides a comparative basis to trader 206A, as to how a given broker, e.g. 202B, is being evaluated by system 200 for other traders 202B . . . 202M. This helps trader 206A gain insight as to whether broker 202B is disfavoring him/her, by applying any execution limits, such as by artificially delaying the trades, increasing the spreads, higher swap prices, etc.

For traders 206A . . . 206M whose historical trading data is available in broker assessment module 220, specifically database 230 (see FIG. 2-3), recommendation engine 262 can perform back-testing of its recommendations 264A . . . 264M based on the historical trading data of traders 206A . . . 206M, as well as the historical pricing and execution data of brokers 202A . . . 202I for the respective financial instruments and platforms—such data including but not limited to spreads, commissions, swaps, volatility, time delay, etc. Recall the explanation of pricing update stream stored in database 230 in reference to FIG. 3. It then refines its recommendations for a given user/trader based on this back-testing and then ranking the broker, on a given platform, that will be the cheapest for a given financial instrument based on that trader's historical trading record, and providing that broker a rank #1 or the first choice for the trader. Next cheapest broker as rank #2 or the second choice, and so on.

As explained above, there are many alternative options of computing pricing-score, and there are additional pricing parameters that may be considered for computing the pricing-score of a broker within the bounds of the present invention. Similarly, there are alternative ways of computing execution-score as well as recommended ranking of brokers, and the execution-score and broker ranking may be dependent, instead of or in addition to, on other execution data elements taught in above embodiments. A non-exhaustive list of additional data elements for potential inclusion in the computation of a broker execution-score and ranking includes:
Execution speed: The elapsed time between order placement on the trader platform and the order confirmation on the trading platform.
Local delay: The ping time from the trading platform to broker server. The local delay incorporates any network or processing delay experienced by the client due to his/her own processing and speed/bandwidth constraints.
Net execution speed: The execution speed adjusted for local delay.
Broker delay: Any delay associated with the network and processing constraints on the broker side.
Average slippage: Recall that slippage is the difference in order submission price compared to the actual order execution price. Slippage is stored in the system and marked as either “price improvement” or “price deterioration”. If on one position, the slippage was negative and on another one it was positive the average slippage is calculated by adding up the two slippages together and then dividing by the number of trades. Typically, the average slippage per instrument is calculated daily.
Positive slippage ratio: The percentage of trades that were executed with the price that was better than the original requested price by the client/trader/user.
Negative slippage ratio: The percentage of trades that were executed with the price that was worse than the original requested price by the client/trader/user.
Re-quote ratio: The percentage of trades that were re-quoted by the broker.
Price-reject ratio: The percentage of trades that were rejected by the broker.
Execution rate: The percentage of all submitted trades that were successfully executed, without a re-quote or a reject.

Broker evaluation system and its methods taught above can also be used to perform a ‘what-if’ analysis by an individual trader. In such an analysis, a trader A would ask the broker evaluation system: What will be my trading costs, if I choose broker X for a financial security Y for a trading platform Z? Trader A will then select broker X, security Y and platform Z from a menu of options, and the system will analyze Trader A's historical trading record and corresponding historical pricing and execution data of broker X for security Y on platform Z (including but not limited to historical spreads, commission, swap, volatility, time delay, slippage, etc.) and then using the techniques taught in the instant invention, determine the actual trading cost that will be expected to be incurred by trader A for using broker X, security Y and platform Z.

The teachings of the present invention also provide for the accounting for network delays associated with a connection between a trader and an online broker. Specifically, execution-score as computed in Equation 14 includes the term average volatility which is dependent on the delay on the network between the trader and the broker. Since average volatility is obtained by dividing the difference between the highest and the lowest bid price by the number of seconds of time delay associated with a trade, and is thus a function of time between the placement of the trade at the client side, and the time at which that trade was actually executed by that broker. Therefore execution-score from Equation 14 implicitly incorporates the speed of the network between the trader and the online broker.

Note that this network delay may include a local or a client component and a remote or broker component. That means that this network delay may comprise a local delay of the user as well as a broker delay on the broker side. Local delay may be associated with the physical location of the trader, that is, the trader's proximity or distance to the location of the broker servers and/or the speed of his/her own network or the network provided to him/her by an Internet Service Provider (ISP), as well as the processing power of his/her system(s). Therefore the execution-score as taught by this invention for the trader implicitly depends on this local delay and is a useful indicator of the effects of such local technical limitations on the broker-scores (and therefore the trader's true trading costs), and on the eventual broker ranking as taught above. Furthermore, as taught above, in any alternative scheme of calculating broker-scores besides Equations 1-14 above, such a dependency of technical and network limitations of client systems on broker-scores and trading costs may also exist. For example, the effects of local delay may also exhibit on the observed slippage of the trades by the trader.

The methods of the instant invention also delineate the steps required to carry out the teachings of the invention. Specifically, the methods provide the steps for evaluating one or more online brokers of financial assets by determining a broker-score of each online broker. The broker-score of each broker is determined based on a pricing-score and an execution-score of the broker. The pricing-score is based on pricing data and execution score is based on execution data of each broker. Broker evaluation is performed by producing a ranked list of brokers based on above broker-score, and then further customizing this list for an individual trader. The ranked list is presented to the trader using a variety of filters that the trader can use as pivots to view broker rankings.

Preferably, pricing-score is computed by multiplying an effective quantity of the financial asset involved in the trade by the spread charged by the broker (as the difference between the Bid and the Ask price), and then adding the commission charged by the broker on the trade and any swap charged by the broker for carrying the trade over to the next trading day. Preferably still, execution-score is computing by multiplying an effective quantity of the financial asset involved in the trade by the average volatility of the financial asset observed during the trade. Broker-score, pricing-score and execution-score thus computed are then aggregated across all applicable transactions to determine the overall pricing-score, execution-score and broker-score of each broker.

In view of the above teaching, a person skilled in the art will recognize that the teachings and methods of present invention can be embodied in many different ways in addition to those described without departing from the principles of the invention. Therefore, the scope of the invention should be judged in view of the appended claims and their legal equivalents.

What is claimed is:

1. A computer system for the evaluation of at least one broker of an Over-The-Counter (OTC) traded financial asset, said at least one broker brokering said OTC traded financial asset over a communication network, and said computer system comprising:
a) a computer program on a non-transitory storage medium for computing a pricing-score of said at least one broker;
b) a computer program on a non-transitory storage medium for computing an execution-score of said at least one broker;
c) a computer program on a non-transitory storage medium for computing a broker-score of said at least one broker, said broker-score based on said pricing-score and said execution-score;
wherein said evaluation is derived from said broker-score.

2. The system of claim 1, wherein said communication network is the internet.

3. The system of claim 1, wherein said pricing-score is derived from pricing data, and said pricing data comprises a spread and a commission applied by said at least one broker.

4. The system of claim 3, wherein said pricing data further comprises a swap applied by said at least one broker.

5. The system of claim 1, wherein said execution-score is derived from execution data, and said execution data comprises an average volatility and slippage of said OTC traded financial asset.

6. The system of claim 5, wherein said execution data further comprises an execution speed, a re-quote ratio, a reject ratio, and an execution rate of said at least one broker.

7. The system of claim 1, wherein said execution-score is further dependent upon a local delay associated with a user of said computer system.

8. The system of claim 1, wherein said broker-score is computed by adding said pricing-score and said execution-score.

9. The system of claim 1, wherein said evaluation comprises a ranking of said at least one broker, said ranking based on said broker-score.

10. The system of claim 9, wherein said ranking is customized for a user of said computer system.

11. The system of claim 10, wherein said ranking is based on a historical trading profile of said user.

12. The system of claim 11, wherein said historical trading profile comprises instruments traded, number of trades per unit of time, position size per instrument, past spreads paid, past swaps paid and past swaps received by said user.

13. The system of claim 1, wherein said OTC traded financial asset is Forex.

14. The system of claim 1, wherein said OTC traded financial asset is selected from the group consisting of stocks, bonds, commodities, futures, forwards, swaps, options and debentures.

15. The system of claim 1, wherein said pricing data and said execution data is collected using a trading platform.

16. The system of claim 15, wherein said trading platform is selected from the group consisting of MetaTrader 4 (MT4), MetaTrader 5 (MT5), CTrader, ActTrader, Trader Workstation (TWS) and an Application Programming Interface (API) enabled trading platform.

17. The system of claim 1, wherein said execution data is collected using an Expert Advisor (EA) software module of a trading platform.

18. The system of claim 17, wherein said trading platform is MetaTrader 4 (MT4).

19. The system of claim 17, wherein said execution data is correspondent to an account on said trading platform, said account selected from the group consisting of a live account and a demo account.

20. A computer system for evaluating one or more brokers of a financial asset, comprising:
a) a means for computing a pricing-score of each of said one or more brokers, said pricing-score based on pricing data of each of said one or more brokers;
b) a means for computing an execution-score of each of said one or more brokers, said execution-score based on execution data of each of said one or more brokers;
c) a means for computing a broker-score of each of said one or more brokers, said broker-score based on said pricing-score and said execution-score;
wherein said system produces a ranking of said one or more brokers based on said broker-score.

21. The system of claim 20, wherein said ranking is customized for a user of said computer system.

22. The system of claim 20, wherein said pricing data and said execution data are historical, and said ranking represents a historical suitability of said one or more brokers for a user of said computer system.

23. The system of claim 20, further comprising a means for performing a ‘what-if’ analysis by a user of said computer system.

24. A computer implemented method of evaluating at least one broker of a financial asset, said method comprising the steps of:
a) determining a broker-score of said at least one broker, said broker-score based on a pricing-score and an execution-score of said at least one broker;
b) determining said pricing-score based on pricing data of said at least one broker; and
c) determining said execution-score based on execution data of said at least one broker.

25. The method of claim 24, further producing a ranking of said at least one broker, said ranking based on said broker-score.

26. The method of claim 25, further providing one or more filters to view said ranking.

27. The method of claim 24, further determining said pricing-score by multiplying a spread by an effective quantity, and then adding to the result, a commission and a swap.

28. The method of claim 24, further determining said execution-score by multiplying an effective quantity by an average volatility.
